(19) United States
(12) Patent Application Publication
(10) Pub. No.: US 2026/0027005 A1
(43) Pub. Date: Jan. 29, 2026

(54) Pressure Wave Apparatus With Double Valve Means

(71) Applicant: STORZ MEDICAL AG, Tägerwilen (CH)

(72) Inventors: Rafael Storz, Kreuzlingen (CH); Markus Belau, Konstanz (DE); Arvid Kühl, Tägerwilen (CH); Lukas Honsell, Reichenau (DE); Felix Gremlich, Kreuzlingen (CH); Thomas Glenzer, Kreuzlingen (CH)

(21) Appl. No.: 19/105,928

(22) PCT Filed: Aug. 16, 2023
(86) PCT No.: PCT/EP2023/072553

§ 371 Date: Feb. 24, 2025

(30) Foreign Application Priority Data
Aug. 25, 2022 (EP) 22192132.3

(51) Int. Cl. A61H 23/04

(52) U.S. Cl. CPC A61H 23/04; A61H 2201/1238; A61H 2201/14; A61H 2201/5056; A61H 2201/5079; A61H 2201/5092; A61H 2203/03

(57) ABSTRACT

The invention relates to an apparatus for treatment with pressure waves, comprising: a projectile (8) guided along a movement path, an applicator (7) at one end of the movement path, pneumatic means for application of pressure to the projectile (8) for the purpose of movement, wherein the projectile (8) is adapted for striking onto the applicator (7) for generating the pressure waves, which pneumatic means comprises a double valve means (1, 2) for application of pressure to the projectile (8) towards the applicator (6) during a first activation time and in the reverse direction during a second activation time, and a control means (54), wherein the apparatus is adapted to maintain a separation time between the activation times and to control an impact speed by means of the separation time.

The invention relates to an apparatus for treatment of the human or animal body with mechanical pressure waves generated by impact of an accelerated projectile onto an applicator.

Apparatus of this type have been known for some time and are increasingly in use. Mechanical pressure waves are used for treatment of the (human or animal) patient, which are coupled-in by placing an applicator onto the patient's body and are generated by a collision of an accelerated projectile with the applicator. The applicator does not necessarily have to be in one piece but can also be composed of a number of different parts or materials.

A technique for accelerating the projectile, which has been proven in practice and has been described many times, is pneumatic. A pneumatic overpressure is coupled-in by application of a pressure to a volume on one side of the projectile movable along a movement path, for example in a pipe segment.

In the prior art, a switching valve is used for this purpose, which is connected to a pneumatic supply, in particular a compressor with adjustable output pressure, and the pulse of which accelerates the projectile from an end of the movement path distal to the applicator towards the applicator. The pneumatic application is switched off when the proximal end of the movement path is reached, i.e., with the impact on the applicator.

In the prior art, the return movement takes place with the aid of a counter-pressure chamber, i.e., a storage volume, into which the projectile moved towards the applicator to a certain extent displaces the air located in front of it, whereby it virtually pumps up this storage volume.

In the prior document EP 2 181 730 B1, which, however, was revoked because of lack of reproducibility in opposition appeal proceedings, in addition to a control of the opening time of the switching valve for the acceleration, which is not explained in more detail, a targeted pressure limitation in this counter-pressure chamber is also discussed. Furthermore, this document mentions the use of a second switching valve for a return of the projectile into the distal starting position after the application by the first switching valve.

The present invention is based on the object of specifying an apparatus of the described type with pneumatic means for projectile movement on this basis, which apparatus is improved with regard to the back and forth movement of the projectile.

In order to achieve this object, the apparatus according to claim 1 is proposed. Preferred configurations are the subject matter of the dependent claims.

Accordingly, the apparatus according to the invention has, as part of its pneumatic means, a double valve means for application of the projectile in both directions, i.e., towards the applicator and vice versa away from it in the reverse direction, i.e., for example the combination of a first and a second valve. This typically takes place repeatedly and iteratively in a sequence. The time phases in which the projectile is applied pneumatically in such a way that it moves in the forward direction, i.e., for example the activation phase of a first valve, is referred to below as the first activation time and vice versa as the second activation time a time phase of a reversed application of the projectile. According to the invention, the apparatus is to be adapted (i.e., in particular a control means present therein is to be adapted) in such a way that a second activation time only begins after the first activation time has ended and a separation time has elapsed. There is therefore a separation time different from zero between the two valve opening times.

The same applies (alternatively or additionally) in the opposite order, namely with regard to a separation time after the end of a second activation time and before the start of a first activation time.

For example, the first activation time can be ended significantly before the impact of the projectile onto the applicator and the second activation time can begin, for example, directly after impact. Then, not the entire available time between the movement start of the projectile and the impact onto the applicator is used for the acceleration in the presence of accelerating pressure, but only a first part thereof. For example, the impact speed of the projectile could thus be reduced without having to lower the accelerating pneumatic pressure. It may be desired, for example, to allow this to be at a higher value for a return which is as fast as possible (with the aid of the second activation time) than is momentarily required for the acceleration in the forward direction.

Consequently, in such a manner, the impact speed can be controlled by the controller, to be precise also independently of a pressure change (for example with a constant pressure).

It may be advantageous nevertheless to be able to reduce the impact speed of the projectile during the collision without reducing the pneumatic pressure. For example, on the one hand, a particularly fast return of the projectile (due to the second valve opening time) and therefore a relatively high operating frequency may be desired, no excessively high intensities (that is to say impact speeds) being intended at the same time for therapeutic reasons or because of the patient's sensitivity to pain. Or it may be desired to work again with a higher impact speed shortly before or afterwards or not to lower the pressure for other reasons.

Moreover, the separation time can also lie completely or partially chronologically after the collision. Then, too fast a return movement or too high a speed at the end of the return movement can be prevented, for example, by a delayed start of the second activation time after the collision, without having to lower the accelerating pressure (for the forward direction). In this context, it should also be taken into account that the collision itself already brings about a certain acceleration of the projectile in the reverse direction according to the laws of momentum conservation.

Of course, both aspects can be combined, namely a part of the separation time before and another part of the separation time after the collision.

Up to now, in the examples, the separation time was considered after a first valve opening time (adjacent to the separation time) and before a following second valve opening time. However, additionally or alternatively, the variation of the separation time can also be varied between a preceding (adjacent) second and a then following first valve opening time. For example, such a separation time can be relevant by a delayed start (and varied with respect to the delay) of the first valve opening time during the acceleration in the forward direction. The projectile movement could therefore initially begin exclusively by a “reflection” at the distal end of the movement path, that is to say by a residual momentum of the projectile after a collision with an apparatus part there. With this residual momentum, the projectile can then already move in the forward direction, but is additionally accelerated at the start of the first valve opening time. The movement part (in the forward direction) without pneumatic acceleration by the first valve can therefore also lie at the start of the movement path in the forward direction (and, of course, in this case, the first valve opening time can end before the collision with the applicator).

A further example relates to such a separation time or a portion of such a separation time at the end of the return movement and before reaching the distal end of the movement path. In this case, too, a variation of the separation time can have an (indirect) influence on the speed of the projectile during the subsequent collision with the applicator, specifically because the just mentioned “reflection” at the distal end can already lead to a different residual momentum at the start of the forward movement depending on the projectile speed when this end is reached.

A further example relates to a variation of the two separation times, e.g. in a complementary manner with respect to one another. In the simplest case, with constant lengths of the valve opening times and a given repetition frequency, one of the two separation times can be lengthened at the expense of the other.

In order to avoid misunderstandings, it should be made clear that the term used here of the valve opening time principally includes both the temporal duration and the position relative to temporal reference points, in particular relative to the respectively other valve opening time. The term thus includes the start and the end of the valve opening time and the distance therebetween, unless expressly only the duration or only a start or end time is mentioned below.

The combination of two switching valves was addressed further above, which represents a possibility for a double valve means provided according to the invention. In this variant, the two valves can be controlled (preferably independently of one another) by the control means. Alternatively, however, a uniform valve can also be used, which is referred to here as a “combination valve” and which, depending on the control by the control means, has at least two switching states, namely a first for application of pneumatic pressure to the projectile in the direction towards the applicator and a second for application of pneumatic pressure to the projectile in the reverse direction. While the combination valve is in the first switching state, there is therefore a first valve opening time and, accordingly, a second valve opening time in the second switching state.

In these two switching states, the pneumatic connection to be applied in the respectively other switching state is preferably ventilated by the combination valve, so that, for example, during the forward movement, approximately ambient pressure prevails on the side of the projectile proximal to the applicator and, in contrast to the conventional procedure with a counter-pressure chamber, there is no dynamic pressure increasing from collision to collision.

Even when using two separate valves, at least one of the two valves is preferably a “two-way valve”, which accordingly carries out a ventilation, provided that it is not switched for application of the pneumatic pressure. However, further switching states are not excluded and the valve is not necessarily limited to precisely two switching states.

A ventilation is otherwise meant to mean a pneumatically highly conductive connection to the external atmosphere or to a reference pressure volume substantially corresponding thereto. It is therefore not a matter of a deliberate delay of the outflow of gas and overpressure in the sense of a throttling.

As an alternative to a ventilation via the combination valve or the two-way valves just addressed, the apparatus could also have, for example, a certain pneumatic leakage and, in the absence of an application of pneumatic pressure, carry out a throttled ventilation itself in this way or in a virtually creeping manner. However, this alternative is less preferred.

Preferably, the first activation time is of variable length in at least two control states with different separation time, that is to say, for example, with a fixed portion of the separation time after the collision with the applicator (including zero). In the simplest case, there are only two control states in this case, but preferably more, wherein, of course, a separation time zero can also exist in one control state if there is at least one other separation time different from zero.

Of course, the second activation time can also be of variable length, but, for example, in the case just described of a fixed portion of the separation time after the collision with the applicator, can also be entirely constant, specifically preferably with regard to duration and/or start and end with respect to the reference.

It was already mentioned at the outset that apparatus of the type considered here typically carry out a plurality of acceleration, collision, and return transport processes of the projectile. In the prior art, the corresponding repetition frequency of such a periodic operation is regularly adjustable. Also in the present case, an iterative (not necessarily periodic) operation and a corresponding design of the apparatus are preferably considered, wherein the corresponding sequence does not necessarily have to begin with a movement in the forward direction.

For example, such a sequence can begin with a first pneumatic pressure pulse for movement of the projectile in the reverse direction into its position distal with respect to the applicator, in order to establish defined initial conditions. Principally, magnets at this distal end of the movement path of the projectile are already known in the prior art, with which the projectile is to be fixed. However, a projectile could be released from this fixing as a result of impacts and such a fixing could of course also be dispensed with.

Otherwise, the explanations do not necessarily relate to each individual movement process during such a movement sequence. The operating conditions can, as will be explained in more detail further below, also be changed during a sequence, with the result that the described separation time possibly does not exist at all in the case of a part of the movement sequences in the sequence.

Further above, details of the present invention have been explained with regard to a separation time between the first and the second activation time. According to a further preferred configuration, the apparatus and in particular the control means can be adapted in such a way that in certain further control states there is no such separation time but instead an overlap time (which is different from zero and therefore the case of a separation time zero) between the first and the second activation time or vice versa. With such an overlap time in certain control states (in the case of existing other control states with separation time), an additional degree of freedom results. For example, this can be used to control the impact speed of the projectile upon impact onto the applicator by changing the overlap time. Specifically, if, in this example, the second valve opening time already begins at a time before the collision during the first valve opening time, a counterforce acts on the projectile in addition to the pneumatic force accelerating in the forward direction. In the simplest case, when using approximately the same pneumatic pressure, this counterforce can be approximately equal in magnitude and virtually neutralize the acceleration. Depending on the magnitude of the portion of the first valve opening time before this time, the projectile is accelerated to a higher or lower speed, which it then approximately maintains, for example, during the overlap time.

In the opposite case, the like applies: if the overlap time arises as a result of the fact that, for example, the second valve opening time is not only used up to the maximum of the complete return of the projectile into the starting position, but also continues somewhat beyond this, but the first activation time already begins during the second activation time, no significant force again acts on the projectile during this overlap time (in the simplest case). Thus, there can be a phase without pneumatic forward acceleration of the projectile (possibly already during the return movement and after the end of the return movement), because pneumatic forward acceleration starts only after the end of the overlap time.

One advantage can consist in the fact that the impact speed of the projectile can be controlled more precisely and/or more easily than in the conventional comparison case, which was dependent on the opening time of the (single) switching valve and, of course, the effective pressure. Real switching valves actually have finite opening and closing times, i.e., they do not open and close instantaneously. This applies above all to the comparison between the closing time and the opening time, for example, in the case of (here preferred) spring-loaded valves, in which the opening process is magnetically and optionally pneumatically assisted using the pressure to be switched, whereas the closing process takes place by a spring which is tensioned during opening. Experience has shown that there can be design-related and also ageing-related deviations and a different ageing behavior between the opening and closing times (here opening time in the sense of the opening process).

In the first above case of an overlap time at the end of a first valve opening time and at the beginning of a second valve opening time, the time period relevant to the projectile acceleration, namely the portion of the first valve opening time before this overlap time, is caused by the time difference between two valve opening processes (firstly of the first and then of the second valve). In the second above case, the overlap time is at the end of the second valve opening time. Here, the pneumatic projectile acceleration in the direction of the applicator becomes essential only at the end of the overlap time, so that the remaining portion of this first valve opening time after the overlap time and therefore the difference between two valve closing processes (firstly of the second and then of the first valve) is the relevant one. In both cases, this is therefore the time difference between similar valve movements.

The inventors have found that, in this manner, above all ageing-related deviations become significantly less noticeable (namely if, for example, the closing time exhibits stronger ageing influences than the opening time), because these influences are at least partially compensated by the described difference formation.

In the cited document from the prior art, on the other hand (with all conciseness of the representation relevant here), an alternating mode of operation of the two mentioned valves can be assumed, which also matches the particularly high intensities of the projectile-applicator collisions and therefore pressure waves aimed for in this document.

A further (alternative or additional) aspect can be to work, on the one hand, with a relatively high pneumatic pressure in order to achieve a rapid return and therefore also a high operating frequency, but, on the other hand, not necessarily having to use high impact speeds corresponding to this high pressure (when such an acceleration pressure is present during the entire forward movement). High intensities are not always desired for therapeutic reasons and are otherwise regularly connected with an increased stress on the patient due to pain or other irritations.

In the first case described above, namely an overlap time at the end of a first activation time, the second activation time and therefore the overlap time are started during a forward movement of the projectile, there is therefore a final phase of this forward movement, in which pressure is present on both sides of the projectile. This results in the possibilities already explained. However, this feature is not mandatory, since even (only) after the impact, that is to say during or at the start of the return movement of the projectile, a presence of pressure on both sides can be expedient. For example, the supply pressure for the return movement, which is desired because of the acceleration of the projectile, can be dimensioned to be somewhat excessive, for example because it is undesirable to allow the projectile to impact distally from the applicator with the same force as on the applicator. In this sense, for example, a simultaneousity of first and second valve opening time at the start of the return movement can have a certain throttling effect with regard to the return movement.

In the second case described above, namely an overlap time at the end of a second activation time, an effect similar to that just described can still be achieved with part of the overlap time during the return movement. The same also applies to such a simultaneousity toward the end of the return movement, that is to say before the next acceleration process or acceleration event. In particular, the overlap time can be partly before and partly after the impact of the projectile on the applicator or else partly before and partly after the point furthest from the applicator has been reached, as will be explained in more detail in conjunction with the exemplary embodiment.

Furthermore, in the first case of the overlap time at the end of the first activation time, it is preferred to end the first activation time during the second activation time and thus to allow the second activation time to typically continue beyond the first activation time. In particular, this of course applies to the described return of the projectile. However, this feature is also not mandatory. For example, the described compensation of the accelerating force by a simultaneousity of first and second activation time (that is to say application of pneumatic pressure on both sides of the projectile) can also take place completely within a first activation time by a comparatively short second activation time. The projectile can then be returned, for example, in a manner already known from the prior art. Principally, even a further second activation time (which is separate from the second activation time during the first) could be used for the return.

Analogously, in the second case of an overlap time at the end of the second activation time, it is also preferred to allow the second activation time to end during the (next) first activation time, in particular in order therefore to bring about the already described pneumatic acceleration process of the projectile in the direction of the applicator.

Preferably, one of the two activation times can be of constant length in comparison between two control states with different overlap time (in this case including zero). In the case of an overlap time at the end of the first activation time, this preferably relates to this first activation time and, in the other case, correspondingly to the second activation time. This therefore means that, in these cases, the differences in the overlap time result from different lengths of the respectively overlapping other valve opening time or the temporal relationships between the two valve opening times. Preferably, the respectively other valve opening time is of variable duration between two such control states with different overlap time (wherein, for example, it could have the same start time in all or some of the control states, measured from the start of the earlier activation time).

Preferably, the portion of the overlap time before the impact of the projectile, that is to say during the forward movement of the projectile from a location distal (relative to the applicator) to the applicator, is significantly greater than the portion or time period attributed to the return movement. This preferably applies to all control states with an overlap time. If the aspect of a certain inhibition of the heftiness of a return movement is not of significance, it may also be preferred for the overlap time to exist exclusively during the forward movement.

In the simplest case, the pneumatic means can comprise a connection for supply from a pneumatic line network, for example in a hospital, or from a compressed gas cylinder. However, preference is given to a pneumatic compressor with which the apparatus according to the invention is locally independent and more mobile in comparison with a compressed gas cylinder. Pneumatic compressors are already known per se in conjunction with such apparatuses. However, the invention offers the particular aspect of not necessarily having to change the supply pressure in different control states with different impact speeds of the projectile. In other words, the compressor can run at the same rotational frequency in such different control states.

Of course, this can first of all simplify the controlling of the compressor, in particular if the latter principally runs at the same rotational frequency in the activated state. Furthermore, the compressor can be operated in the vicinity of its or at its maximum efficiency (with respect to the rotational frequency). Moreover, it is possible to match noise reduction measures, for example a damping mounting of the compressor or a noise-damping casing, to the vibration behavior of the compressor at the same rotational frequency.

A particular design possibility of the invention is based on being able to influence the impact physics between projectile and applicator directly and rapidly solely by changing valve opening times or valve opening time durations, specifically the impact speed and therefore the impulse upon impact. In comparison with a change in the supply pressure, this possibility of influencing is particularly rapid, such that, in an iterative operating state, in principle the impact speed/impact impulse of the combined forward and return movement can be changed from one impact process to the next. Such a rapid and free influencing or control action is not enabled by the prior art.

Typical impact speeds are in the range between 2 m/s and 30 m/s, but also in the case of conditions which change less rapidly or do not change. For impact physics, above all the impact pulse is important, which, in the case of typical projectile masses, can be between 1 g and 10 g, preferably between 2 g and 5 g, and therefore in a range from 2 gm/s to 300 gm/s. A range between 10 gm/s and 150 gm/s is preferred.

In a particular configuration, the apparatus has a measuring means, with which the passage of the projectile can be measured at a point of its movement path. This measuring means can be coupled to the control means. Thus, in such a form, for example, the passage of the projectile shortly before impact or quasi during impact onto the applicator can be detected, so that the activation times can be matched accordingly (in particular with regard to their start and their end) to the end time of impact.

Such a detection can take place, for example, optically, for example, by a light barrier or the like, but preferably inductively using at least one measuring coil. This can detect the projectile by a residual magnetism of the projectile or purely inductively (by changing the leakage inductance).

The invention will be explained in more detail below on the basis of exemplary embodiments, wherein the individual features can also be essential to the invention in another combination within the scope of the claims.

In detail,

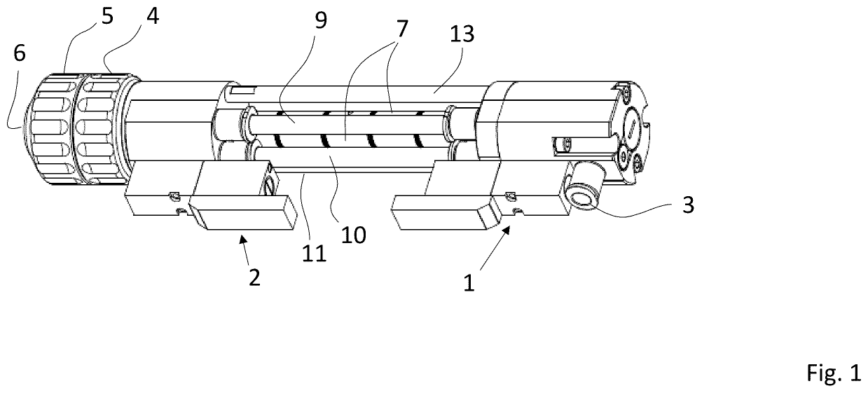

FIG. 1 shows a perspective illustration of an apparatus according to the invention, wherein a central housing part is omitted for the sake of clarity;

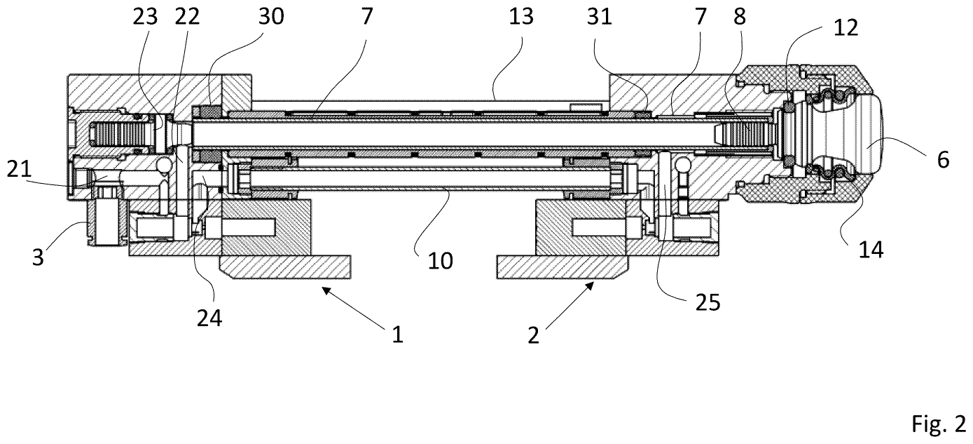

FIG. 2 shows a longitudinal section through the apparatus from FIG. 1 in the right-left-reversed position with respect to FIG. 1;

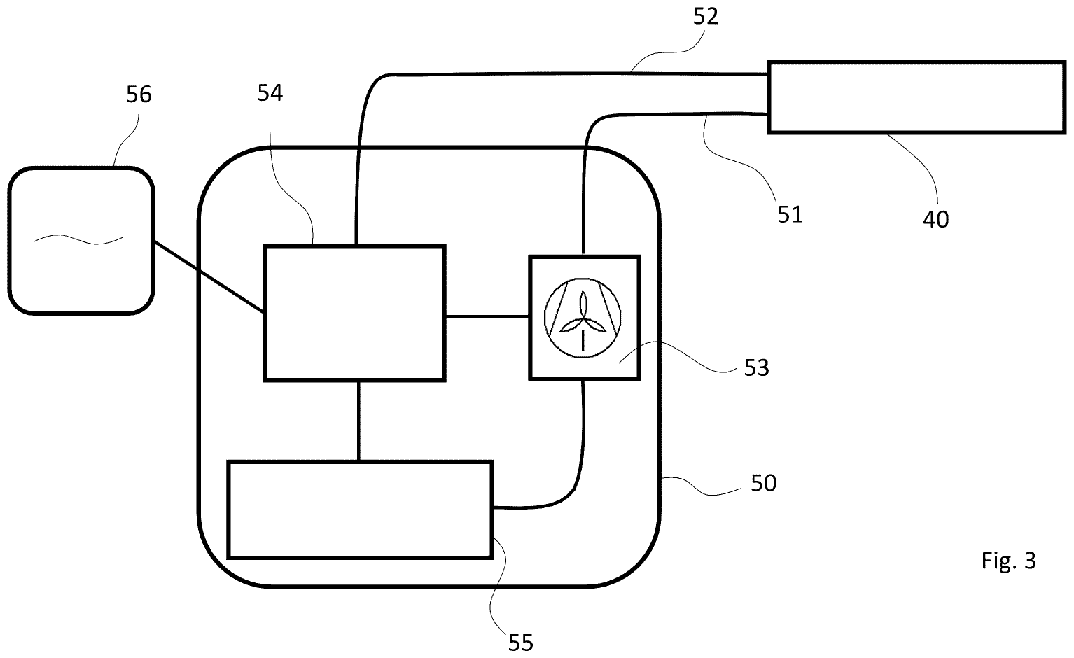

FIG. 3 shows a schematic diagram of the handpiece with an associated basic apparatus;

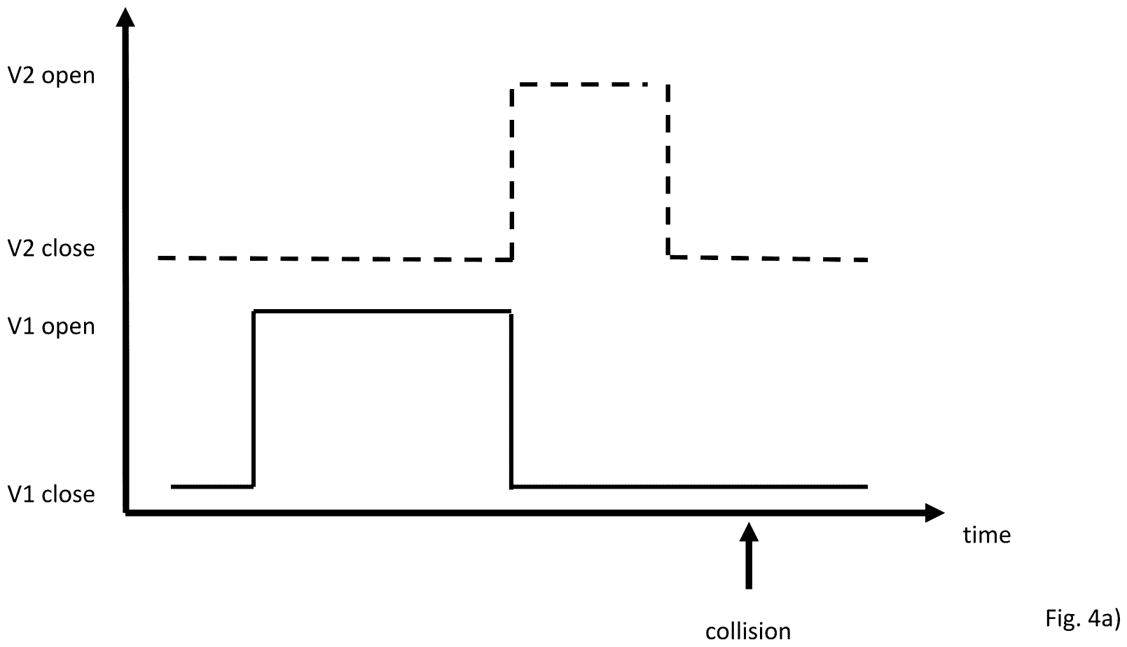

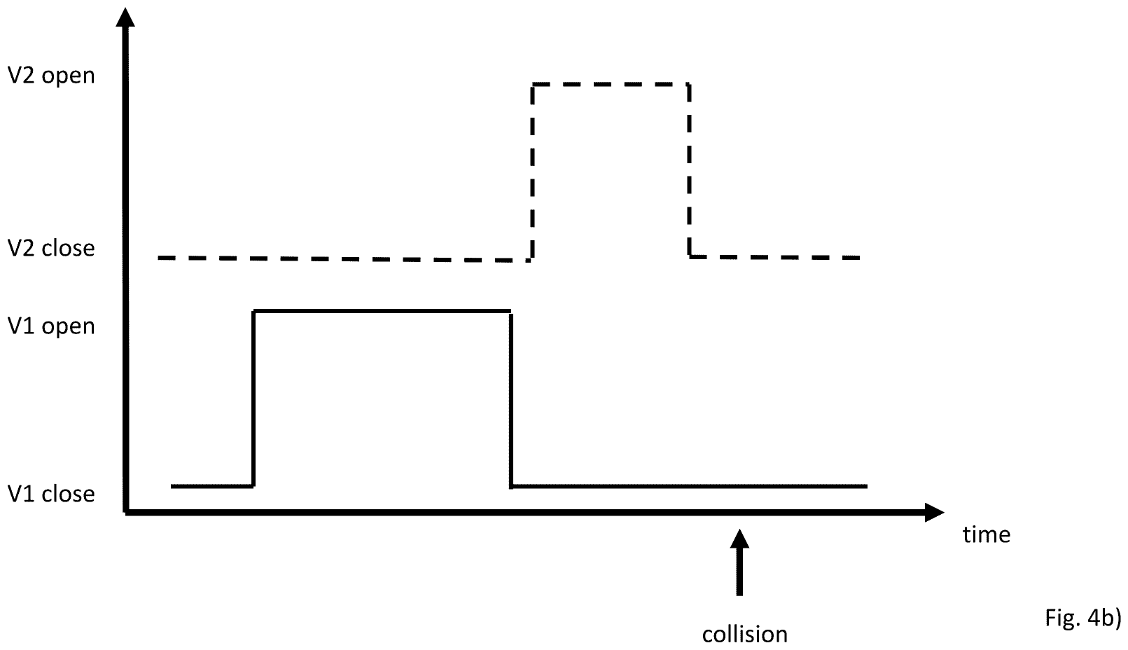

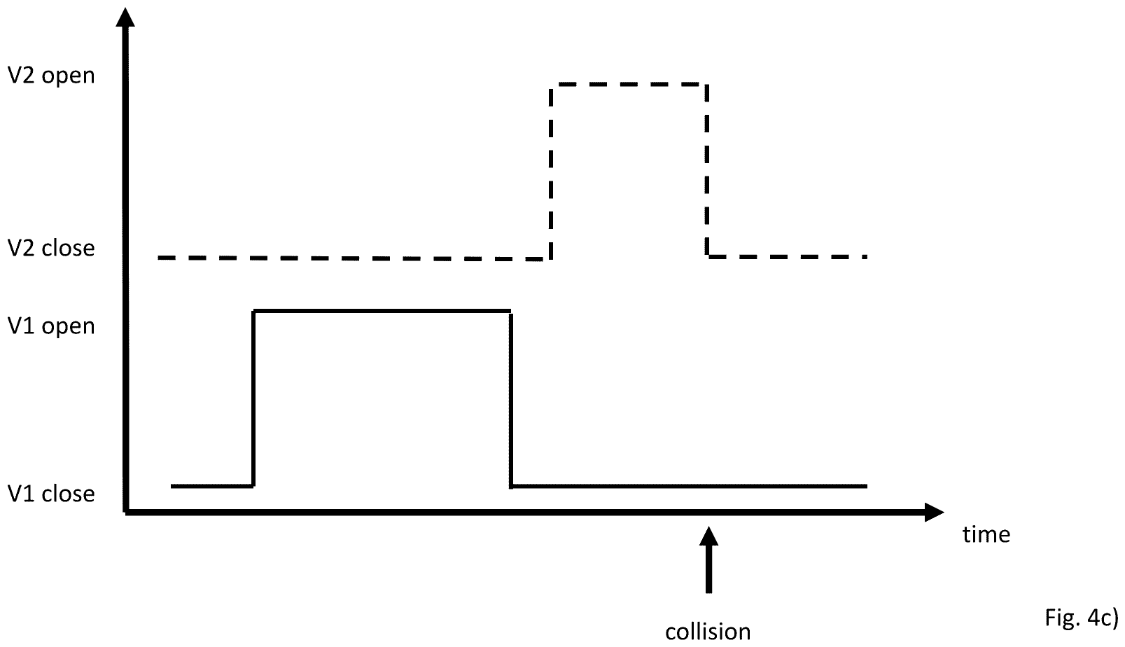

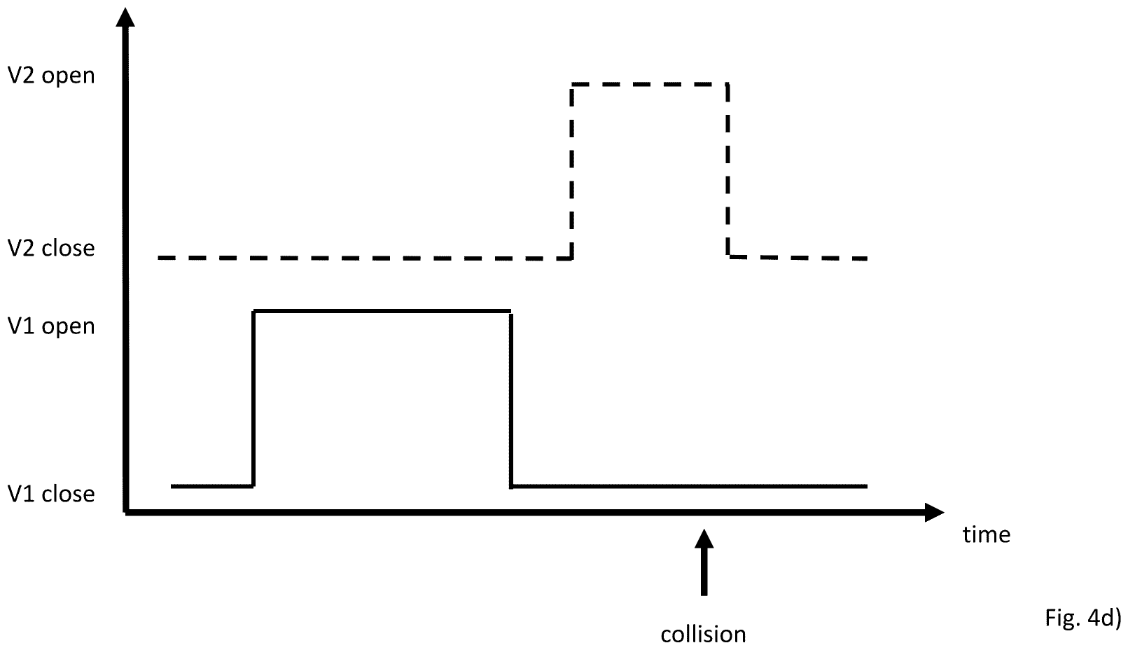

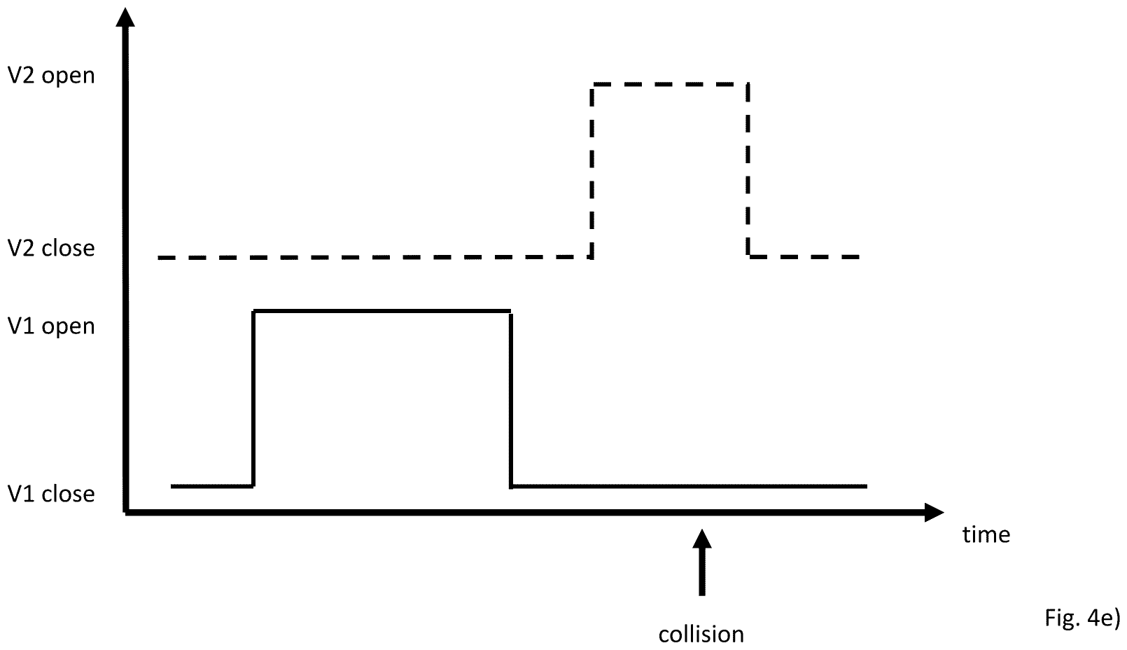

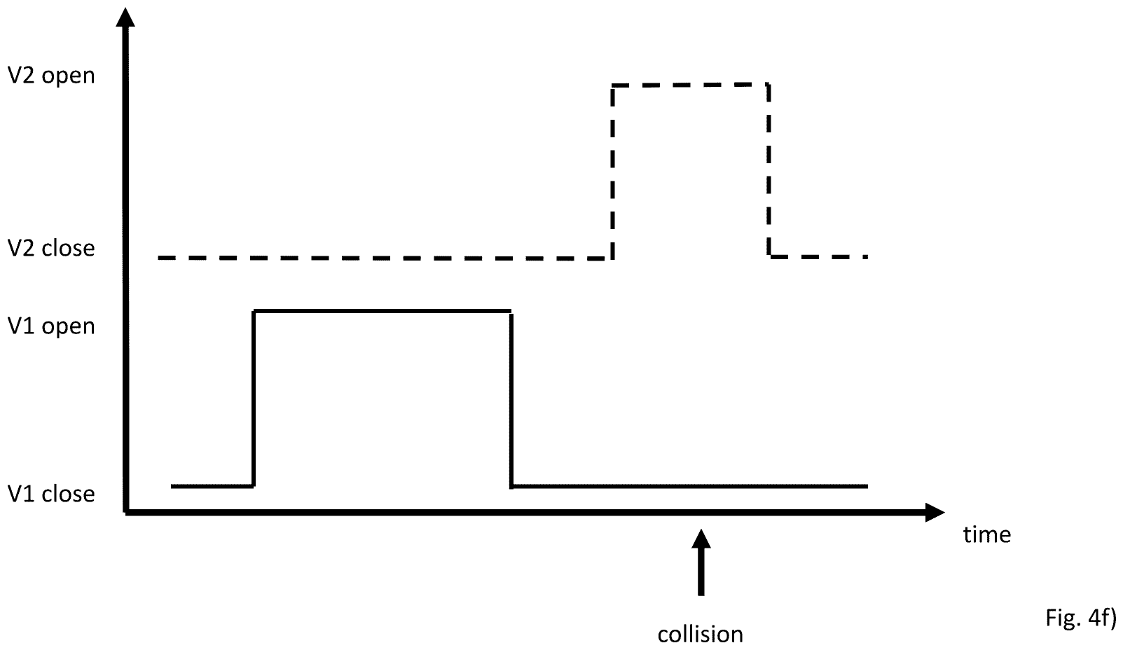

FIG. 4 shows a sequence of schematic time diagrams 4 a) to f) for explaining the mode of operation;

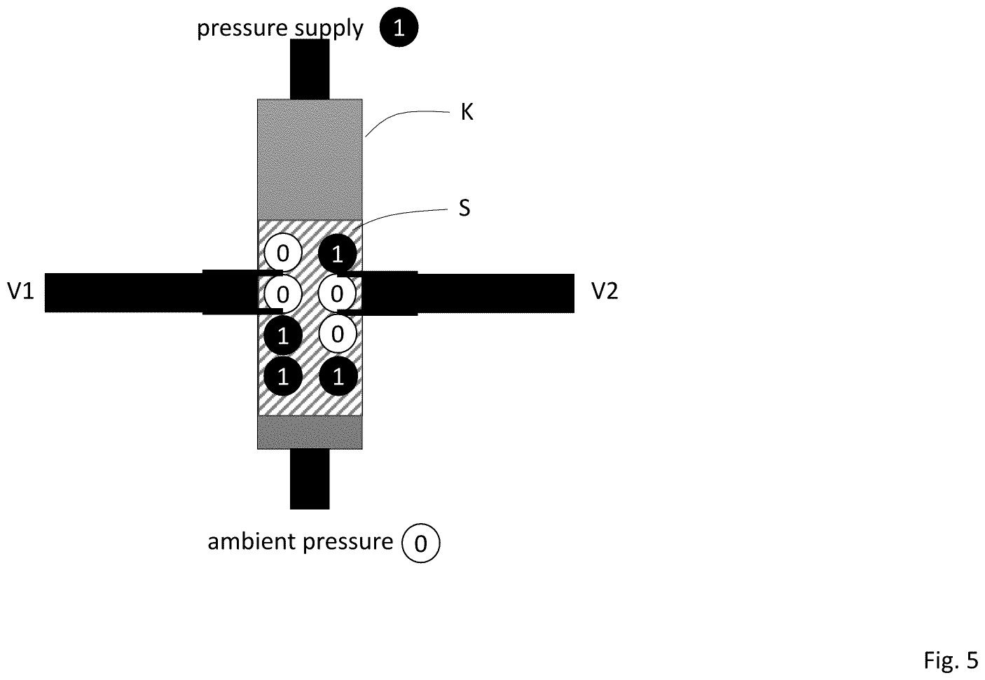

FIG. 5 shows a schematic illustration of a combination valve for explaining an alternative exemplary embodiment to FIGS. 1 and 2;

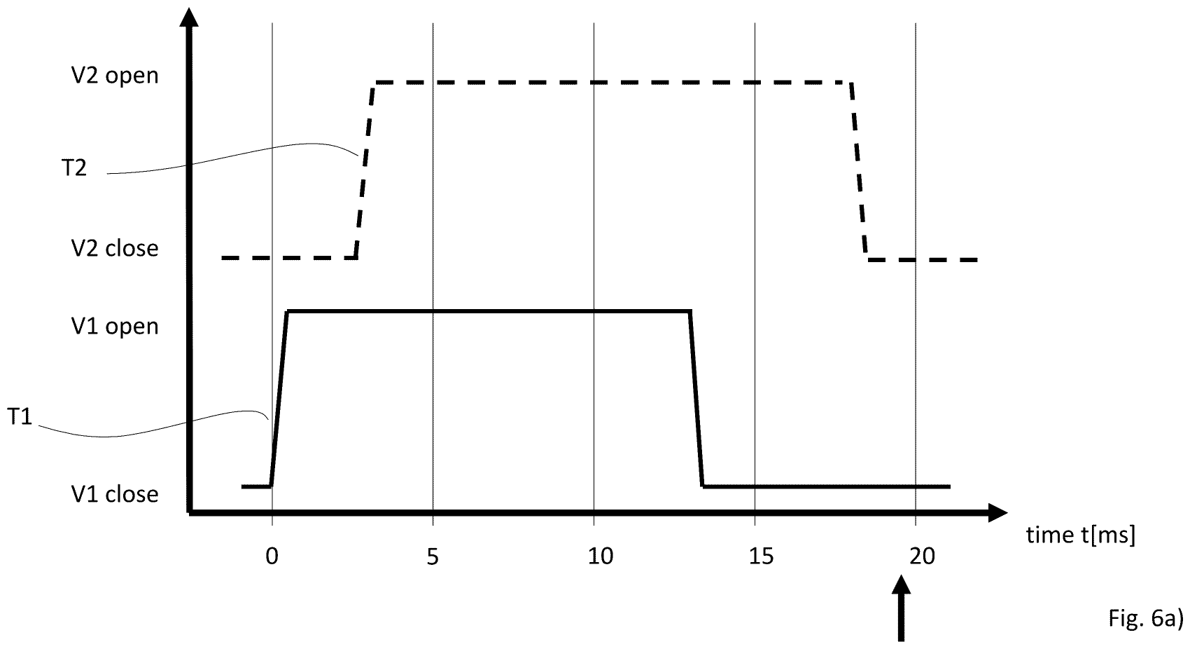

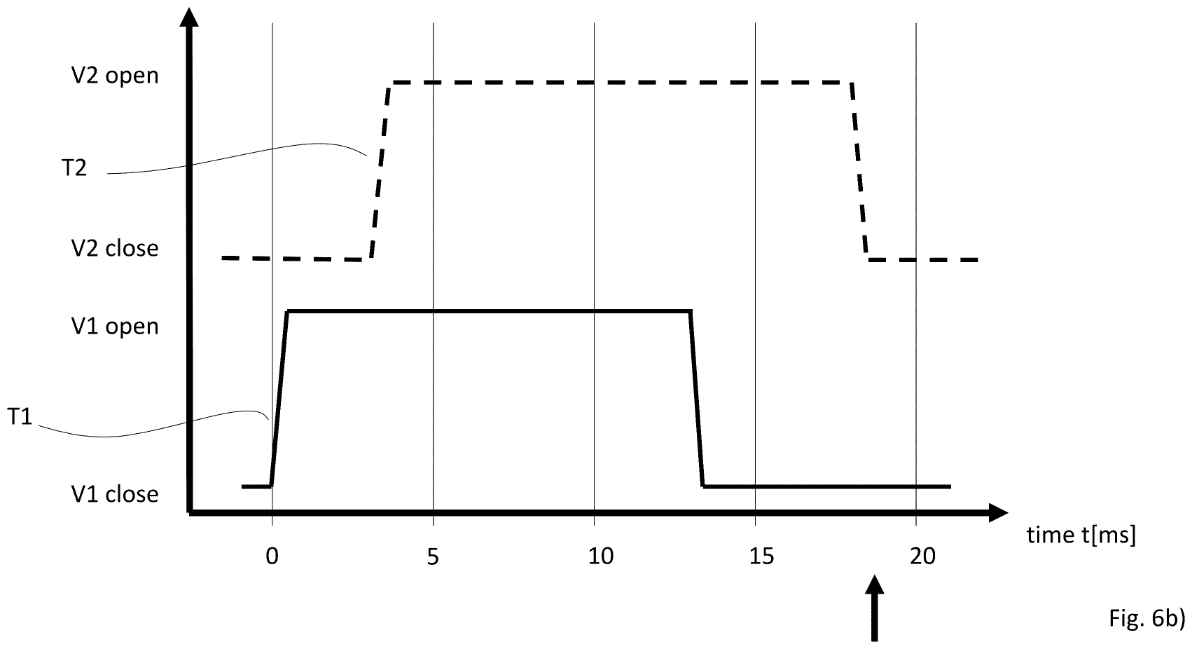

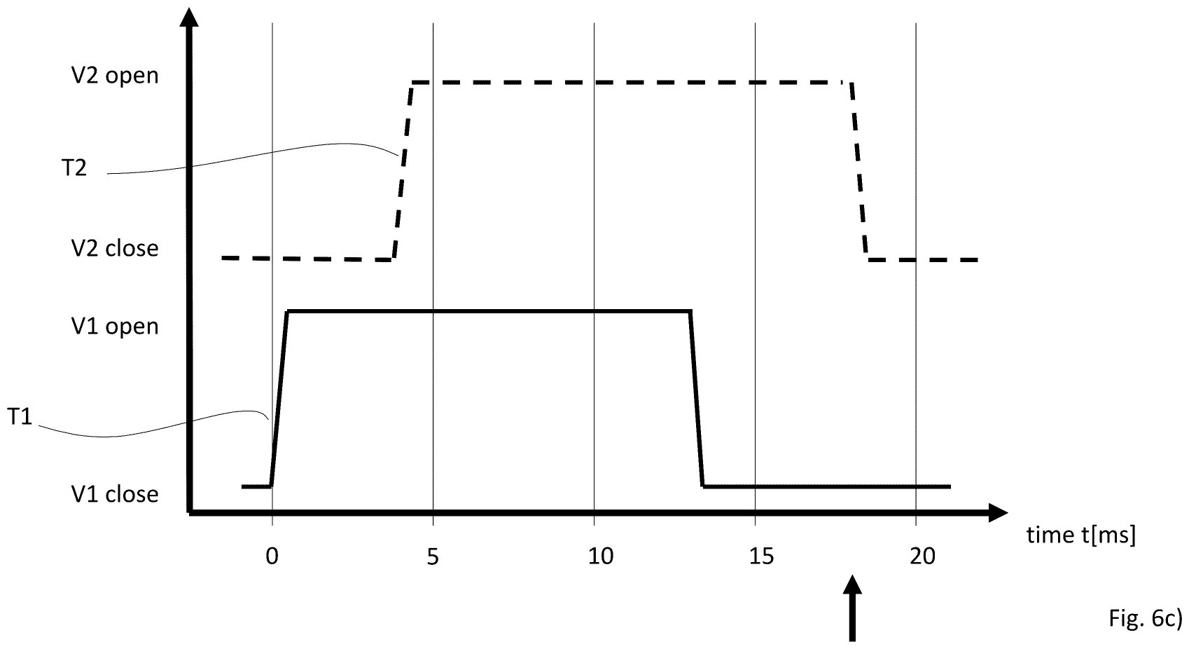

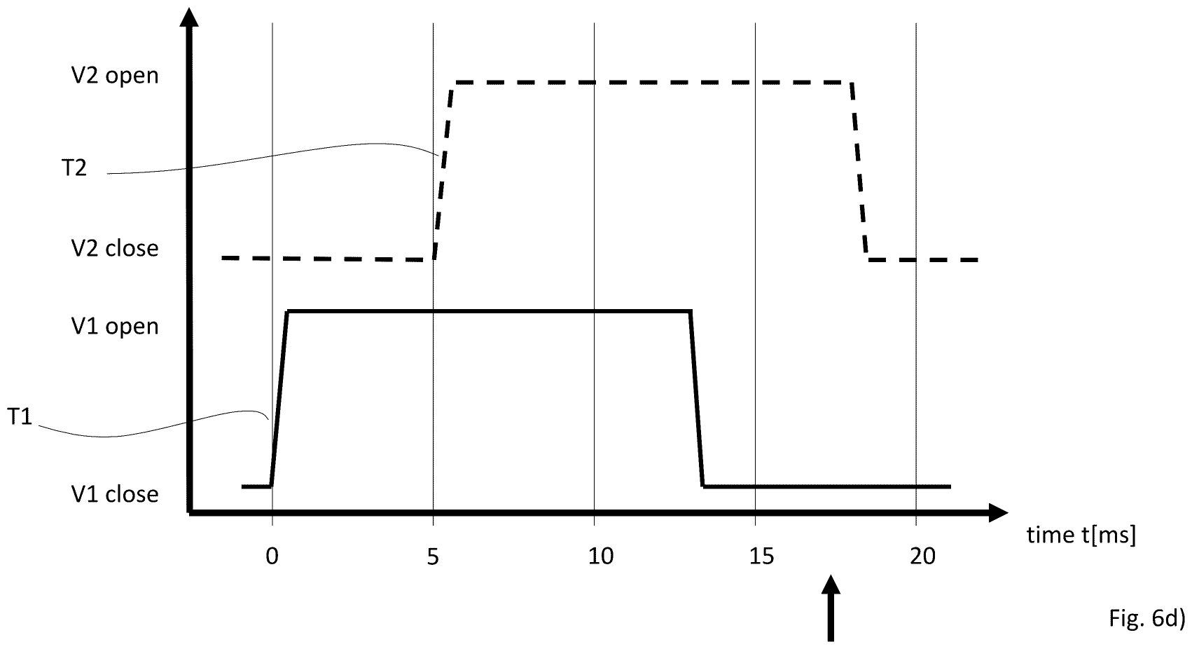

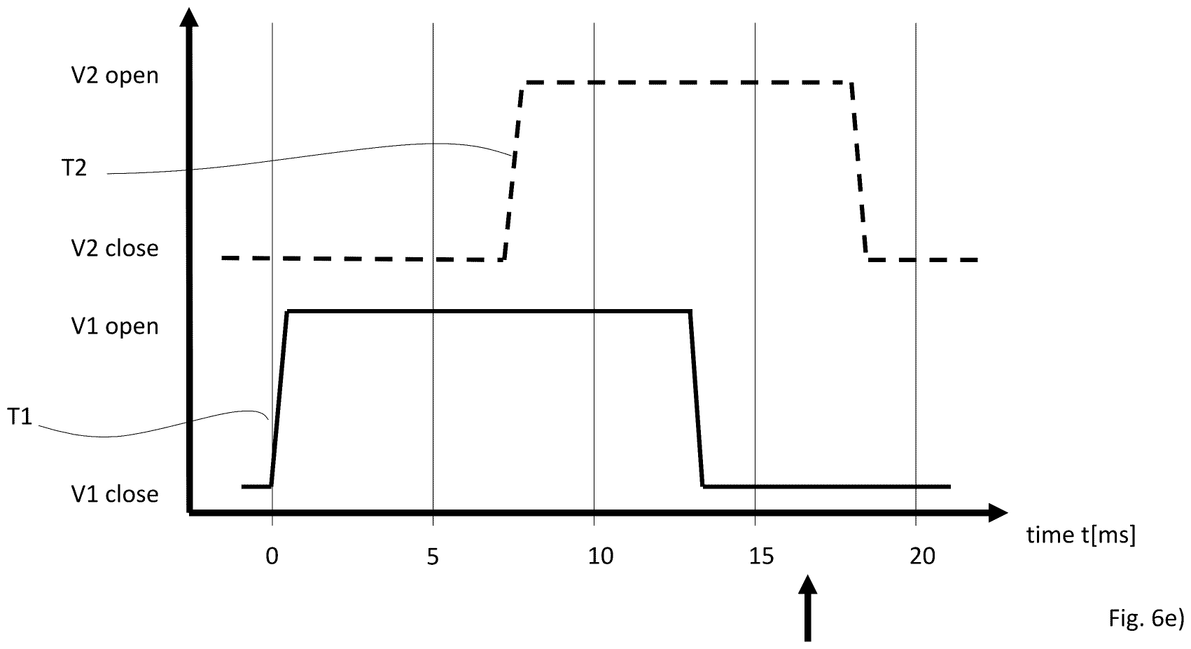

FIG. 6 shows a sequence of schematic time diagrams 6 a) to e) for explaining further control states in addition to FIG. 4;

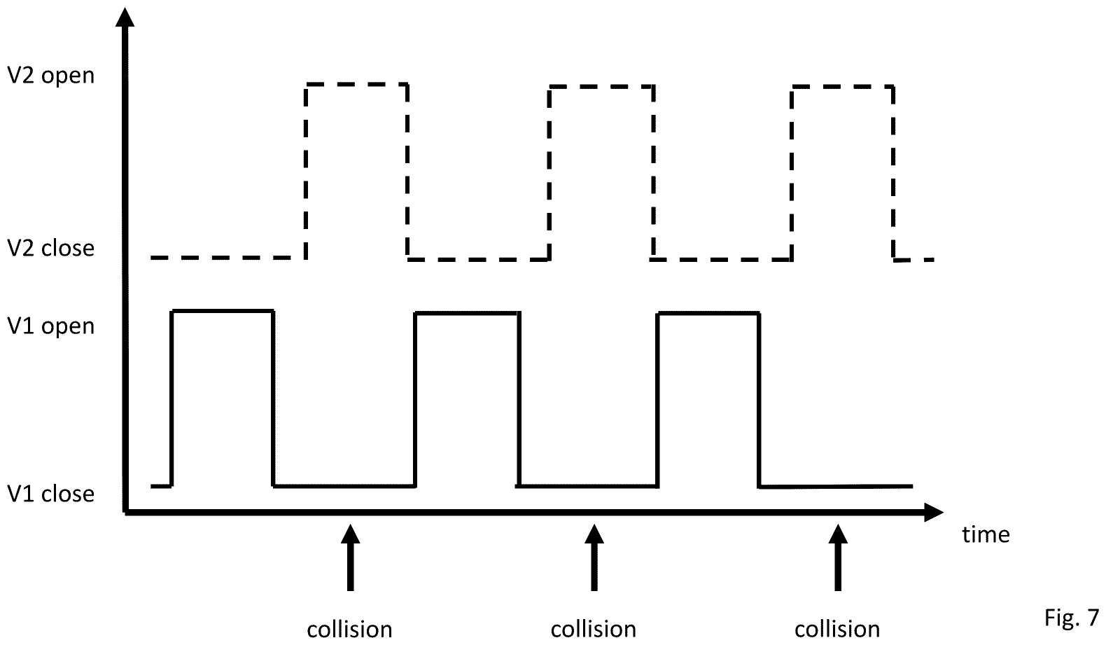

FIG. 7 shows a further schematic flow diagram for explaining the periodic mode of operation;

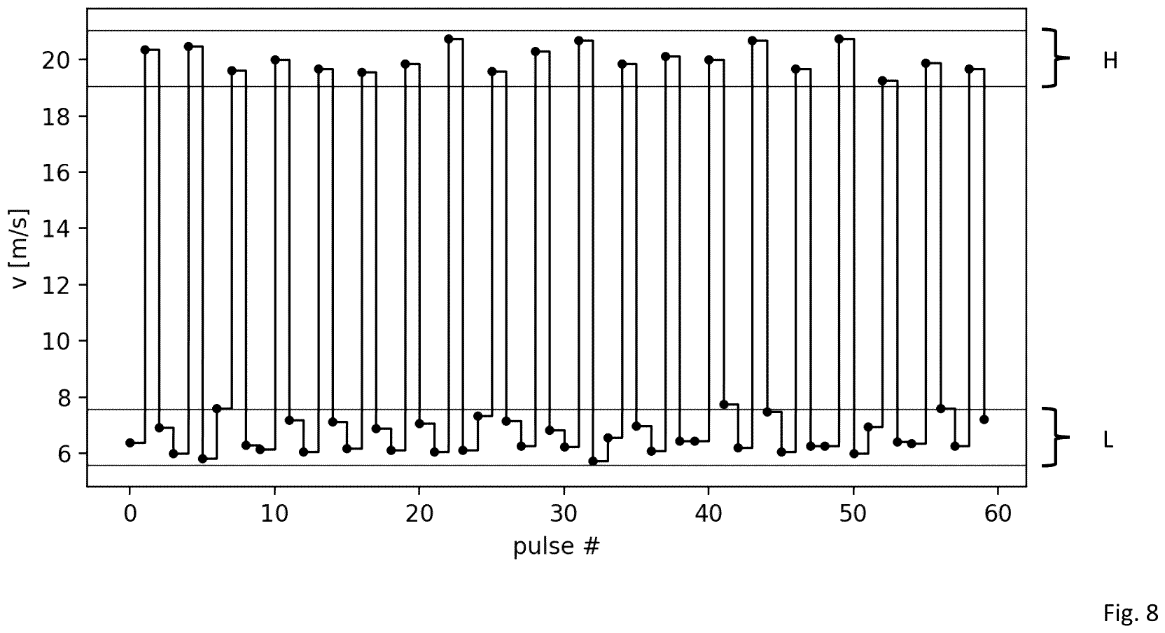

FIG. 8 shows a recurring sequence of two different projectile speed levels in direct succession, two pulses at low speed following directly after a pulse at high speed;

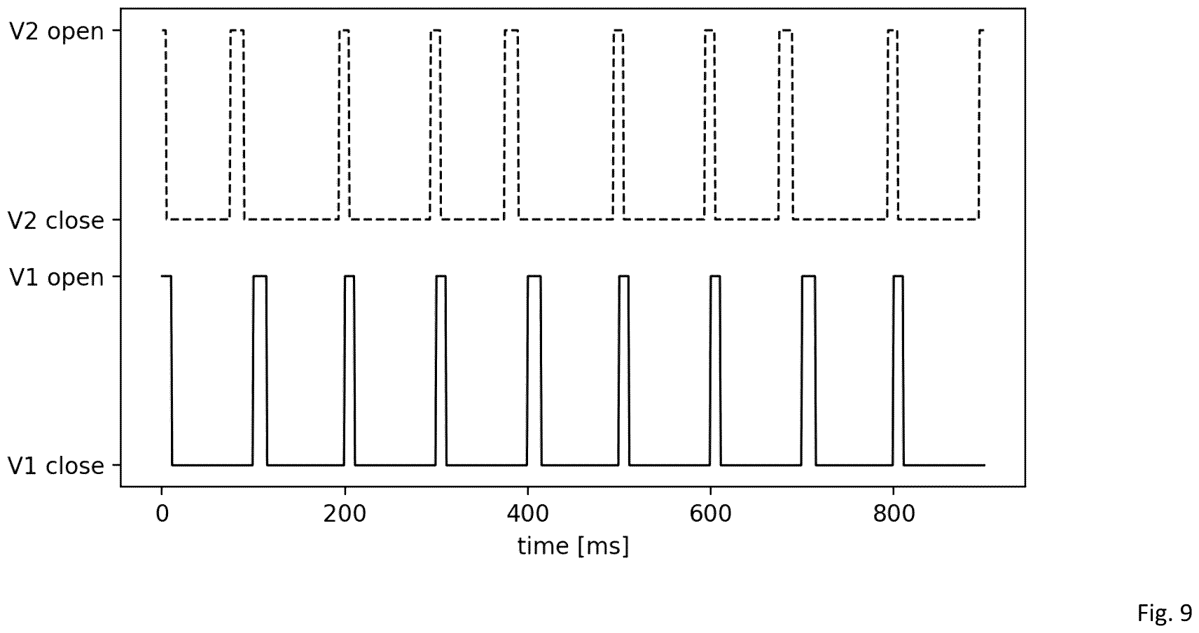

FIG. 9 shows a control sequence for controlling the valves V1 and V2 according to the sequence of two different projectile speed levels shown in FIG. 8;

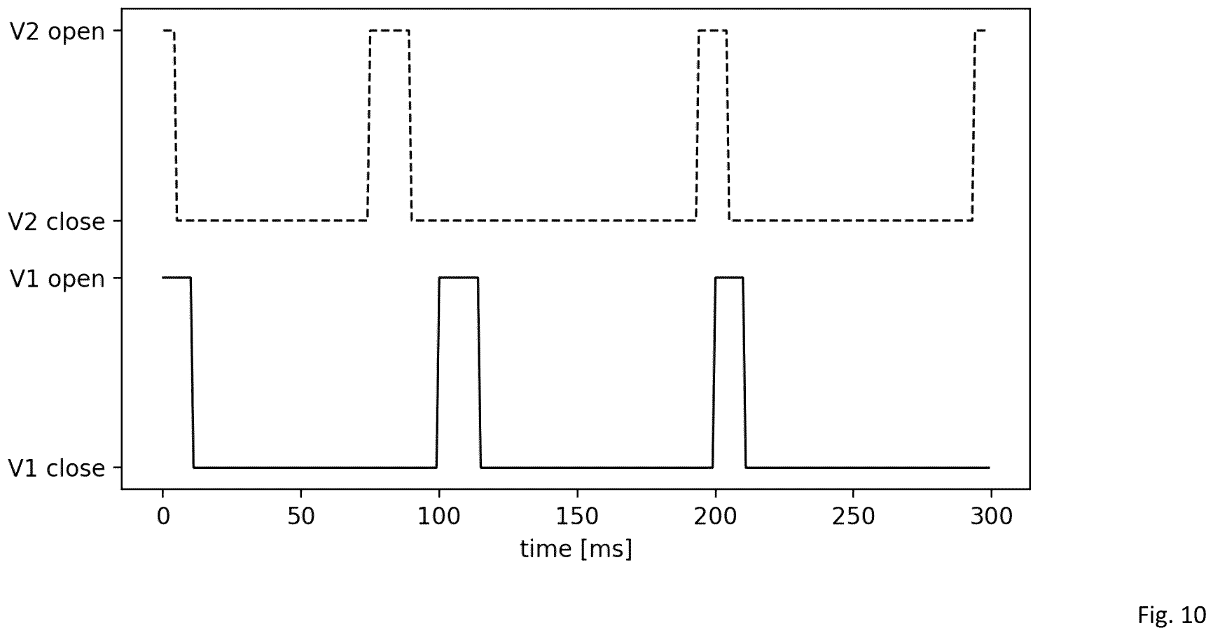

FIG. 10 shows a higher temporal detailing of the first 300 ms from the control sequence of FIG. 9.

FIG. 1 shows a handpiece of an apparatus according to the invention in a perspective view with pneumatic valves pointing to the front-left, namely a first valve 1 and a second valve 2. A pneumatic supply connection 3 can be seen on the right and two screw rings 4 and 5, which are respectively corrugated on the outside for easier handling, for holding the applicator 6, which will be explained in more detail below, can be seen on the left. The latter can still be seen on the far left in FIG. 1 with its patient-facing surface and is otherwise shown in FIG. 2. It could also be constructed in multiple parts.

A number of tubes running in the transverse direction can be seen in the central region of the apparatus from FIG. 1, wherein the central tube with the reference numeral 7 contains and guides the projectile 8, which can be seen in section in FIG. 2. Two parallel pneumatic connecting pipelines 9 and 10 can be seen in front of this between the two valves 1 and 2, wherein the pipeline 9 serves for supplying a pressurization/pressure application to the second valve 2 and the pipeline 10 conversely serves for ventilation of this second valve 2 via an outlet provided in the first valve 1. In this exemplary embodiment, this number of pipes is surrounded by a housing cover 11, which is shown in FIG. 1 by the line below the pipeline 10 and the two lines above the projectile guide pipe 7. This housing cover 11 runs in the rear region in FIG. 1 and comprises only a part of the circumference. At its respective axial edges, it is designed in a manner similar to a flanging by means of a rounded turnover inwardly in a manner favorable to the grip, which is indicated in FIG. 1 at the upper edge. The housing cover 11 can thus serve as a handle during practical handling. The spacer 13 stabilizes the construction and connects the two ends of the handpiece mechanically.

A flexible compressed air feed line (cf. 51 in FIG. 3) leading from a pneumatic compressor to the apparatus is not shown here and is to be connected to the already mentioned connection 3. Analogously, an electronic control line (52 in FIG. 3) from an external controller to the valves 1 and 2 is not shown, which can be designed in a uniform manner with the compressed air feed line.

FIG. 2 shows a longitudinal section along an imaginary central longitudinal axis of the already mentioned cylindrical shape of the overall apparatus, which is at the same time a central longitudinal axis of the projectile guide tube 7. In this projectile guide tube, the projectile 8 is shown on the right in FIG. 2 and thus abuts the applicator 6, which is held by the described screw ring 4 and 5 in a manner known per se. In this case, the applicator 6 is elastically mounted in the axial direction by a bellows-like elastomer ring 14 and is pneumatically sealed by a further elastomer ring 12. Alternatively, an apparatus design with regard to the applicator 6 and its holding and sealing according to, for example, EP 2 529 679 (also independently of the cap shown there) or EP 2 095 843 (also independently of the ceramic material discussed there) is also possible and preferred.

FIG. 2 shows on the left an inner channel 21, which connects the pneumatic connection 3 to the first valve 1. The first valve 1 can accordingly switch a supply pressure applied to the pneumatic connection 3, depending on the control, to a radial channel 22, which opens under a damper element 23 and is thus connected to the inner volume of the projectile guide tube 7. Via this channel 22, the projectile is therefore acted upon or accelerated during a first activation time in the direction of the applicator 6. Independently of this, the pneumatic supply pressure is passed on to the second valve 2 via the channel 24 and the pipe 10.

In the second alternative switching position, the channel 22 and thus also the inner volume of the projectile guide tube 7 between the distal end (on the left in FIG. 2) and the projectile 8 are ventilated.

In the second valve 2, which is constructed principally mirror-symmetrically with respect to the first valve 1, the pneumatic supply pressure applied via the pipe 10 can alternatively be passed radially upward via the channel 25 to a volume surrounding the projectile guide tube 7 (to be seen in FIG. 2 as a slot above and below the pipe 7), which leads from the connection of the channel 25 to the right, i.e., in the direction of the applicator 6, and is connected there between the applicator 6 and the end of the projectile guide tube 7 proximal to it to the inner volume of the projectile guide tube 7 (apart from the presence of the projectile 8 shown there in FIG. 2). Via the channel 25, the pneumatic supply pressure can therefore be applied switchably to the inner volume of the projectile guide tube 7 between the applicator 6 and the projectile 8. In this example, however, the pneumatic connection is somewhat poorer as a result of a smaller effective opening cross section than on the opposite side of the projectile guide tube 7, so that, here, at higher air flow speeds (higher frequencies, higher pressures), delays become noticeable earlier or more strongly.

Alternatively, in the other switching position, the second valve 2 can block the connection of the inner volume of the pipe 10 to it and ventilate the channel 25 and thus the inner volume of the projectile guide tube 7 on the right of the projectile 8, i.e., connect it to the external atmosphere via a pneumatically highly conductive connection.

The two valves 1 and 2 can therefore apply pneumatic pressure to the projectile from both sides, namely independently of one another and thus simultaneously or alternately, or can ventilate the interior of the projectile guide tube 7 on both sides.

The reference numeral 30 in FIG. 2 denotes a ring-shaped permanent magnet at the end, which is distal with respect to the applicator 6, of the movement path of the projectile 8 (coinciding with the length of the projectile guide tube 7). With this magnet 30, the projectile 8 constructed from ferromagnetic material can be easily fixed at this distal end of the movement path. By unilateral pressurization by means of the valve 2, the projectile can furthermore be returned to this position and optionally also additionally held there, in particular at the start of operation or in the case of a non-ferromagnetic projectile. In this respect, the permanent magnet 30 can optionally also be omitted, especially when the reflections, which are still to be explained in the further course, at this distal end of the movement path are to be made possible there even at low impact speeds of the projectile 8.

Reference 31 denotes a point at which the passage of the projectile 8 through the corresponding point of the movement path could be detected with a measuring coil, this point lying relatively close to the applicator 6. In the simplest case, a slight residual magnetism of the projectile 8 is used here, but the changing of the inductance of the coil 31 could of course also be detected and evaluated using alternating current technology. The collision of the projectile 8 with the applicator 6 can also be determined by the use of a microphone or movement sensor in the experimental setup. In addition, the impact speed of the projectile 8 can be determined in the experimental setup, for example, with two light barriers positioned just in front of the applicator 6.

FIG. 3 shows a block diagram with the apparatus shown in FIGS. 1 and 2 at the top right, to be precise denoted in summary by the reference numeral 40. This apparatus 40 is a mobile handpiece to be held in the hand, as is already known per se from relevant apparatuses from the prior art. It is connected via two lines 51 and 52 to a base station 50, which contains a pneumatic compressor 53 and a controller 54. The compressor 53 is connected via the line 51, namely a pneumatic flexible hose line, to the handheld apparatus 40 and the controller 54 is connected via the electrical line 52 (optionally integrated with the line 51), via which the controller can access the already mentioned two valves 1 and 2 and supply them with power. In addition, communication with the handpiece 40 can take place via the line 52, in particular if a controller or a part of the controller is additionally provided there.

Moreover, the controller 54 also controls the compressor 53 with respect to its rotational frequency and, of course, the switching on and off and, in turn, is supplied with power by a mains apparatus 55, just like the compressor 53. However, a pressure control influencing the rotational frequency or a control valve can also be integrated in the compressor 53. In addition, the controller 54 is connected to a display 56, which can be installed in the basic apparatus 50 or can also be implemented separately therefrom. The basic apparatus 50 is operated via a touch-sensitive screen 56 and/or via an arrangement of buttons, not shown here.

The user can thus control the function of the apparatus 40 on the basis of such buttons and in any case on the basis of the display 56, wherein the controller 54 specifies in particular the opening and closing times and thus also the opening durations of the two valves 1 and 2. Partial tasks of the controller 54 can also be integrated in the handpiece 40, particularly with respect to the controlling of the valves 1 and 2.

For a basic understanding of the controlling of the two valves, reference can be made to the earlier patent EP 2 213 273 B1. With regard to the dimensioning in particular of the projectile guide tube and of the projectile, the exemplary embodiment therein corresponds largely to the above explanations and to FIGS. 1 and 2 with the exception of the existence of the second valve 2 and the omission of the counterpressure chamber. In addition, in the exemplary embodiment cited, a specific valve opening time of the single valve there is assumed at a specific pressure, whereas the projectile acceleration in the present case takes place variably by means of the portion of the first valve opening time also outside the overlap time and therefore also at a constant pressure. For the following explanations, a pressure of 2 bar and a repetition frequency of 10 Hz can be assumed by way of example. This results in the following table of values with measured values:

| projectile speed [m/s] | 4.7 | 6.2 | 8.1 | 9.5 | 10.3 | 10.8 |
|---|---|---|---|---|---|---|
| opening time valve 1 [ms] | 0 | 0 | 0 | 0 | 0 | 0 |
| closing time valve 1 [ms] | 13 | 13 | 13 | 13 | 13 | 13 |
| opening time valve 2 [ms] | 13 | 14 | 15 | 16 | 17 | 18 |
| closing time valve 2 [ms] | 21 | 22 | 23 | 24 | 25 | 26 |
| impact time [ms] | 25.0 | 24.6 | 24.2 | 23.9 | 23.8 | 23.7 |

FIG. 4 shows schematic time diagrams which correspond to the above table in the individual illustrations a) to f). There are different separation times between the controlling of the valve 1 from FIGS. 1 and 2, which is represented by the solid line at the bottom, and the controlling of the valve 2, which is illustrated by the dashed line at the top. There is generally an activation pulse for the valve 1, whereby the projectile 8 is accelerated and then “flies on” for a different part of the movement path without further pneumatic application after the end of this first activation time. In this movement phase, both sides of the tube interior are ventilated (and not pressurized). In FIG. 4 a), this only applies after the second activation time.

After a certain time of the deceleration by the second valve, a collision with the applicator 6, which is shown, occurs and thereafter the return movement of the projectile 8 on account of this collision and of the returning pneumatic pulse as a result (of the remainder) of the second activation time occurs. The projectile 8 is thus moved back into the starting position again.

The length of the first activation time is left unchanged. In this example, at least a part of the second activation time lies before the collision, specifically the entire second activation time or the predominant part in cases a) to e), approximately half in case f).

These illustrations illustrate a further possibility of controlling the speed of the projectile 8 during the collision. In FIG. 4 a), the projectile 8 is namely pneumatically accelerated over the first activation time, in order then to be delayed by an opposing pneumatic pressure as a result of the beginning of the second activation time (dashed above). Since in case a) the delay time is in a ratio of 8:13 to the acceleration time and the same pressure level can be assumed, the projectile 8 strikes the applicator 6 at a minimum speed and is moved back again to the starting point after the impact on the applicator 6 on account of the elastic impact.

In cases b) to f), the separation time between the two activation times is longer and therefore the portion of the second activation time before the collision is smaller in steps, which leads to an increasing projectile speed during the collision despite an unchanged first activation time.

More precisely, FIGS. 4 a) to f) show the electrical control times of the two valves 1 and 2, that is to say the output signals of the controller 54. The valves 1 and 2 are spring-assisted solenoid valves which open purely magnetically and close by the force of the spring which is tensioned in the process when the magnet is no longer loaded. The movements of the valve body are accordingly somewhat delayed with respect to the control signals illustrated, specifically by an estimated 4 ms during opening and 2 ms during closing.

In the case of a so-called pilot valve with pneumatic assistance during opening, the situation would be qualitatively comparable.

Of course, in the case of another exemplary embodiment with a “combination valve”, very similar relationships can be generated as illustrated in FIG. 4 in the diagrams a) to f). Such a combination valve is illustrated schematically in FIG. 5. In this case, the letter K denotes the combination valve, which accordingly replaces the two valves 1 and 2 from FIGS. 1 and 2. Two lines V1 and V2 are illustrated on the right and left, of which V1 means a connection to the left-hand side (according to FIG. 2) of the projectile guide tube 7, for example via the channel piece 22 (analogously to the first valve 1). Accordingly, the right-hand line V2 means a connection to the righthand side of the projectile guide tube 7 (analogously to the second valve 2), i.e., for example via the channel piece 25.

The upper line is denoted in FIG. 5 by the keyword “pressure supply” and the symbol “1” (not to be confused with the reference numeral 1) for the first valve; analogously, the lower line connection is denoted by the keyword “ambient pressure” and the figure-internal symbol “0”, i.e., means a ventilation opening.

There is a slide S, illustrated symbolically, in the combination valve K, which slide can be displaced in the vertical direction (with respect to FIG. 5) between four different switching positions. In the uppermost position, as illustrated in FIG. 5, the connection V1 is ventilated and the connection V2 is applied with the pneumatic supply pressure, in the third position, from above, vice versa, and in the second position, which has just been switched actively, from above, both connections V1 and V2 are ventilated. Finally, the lowermost position shows a simultaneous pressurization of both connections V1 and V2, cf. further below.

It would therefore be possible to imagine a combination valve K constructed in this or a similar manner instead of the two individual valves 1 and 2 from the exemplary embodiment in FIGS. 1 and 2, wherein the remaining explanations and in particular FIGS. 3 and 4 also apply analogously thereto.

Owing to the possibility of controlling the impact speed of the projectile 8 solely via the switching operation of the two valves 1 and 2, the pneumatic compressor 53 (FIG. 3) runs at a predefined fixed operating frequency at which it has a maximum efficiency. In addition, the pneumatic compressor can be particularly effectively damped in terms of vibration and noise at a predefined operating frequency.

Principally, the control means 54 can vary the impact speed and also the time interval between the collisions between the projectile 8 and the applicator 6 from one to the next individual operation. It can therefore influence the impact physics significantly more rapidly and more variably and is in particular not tied to periodic operations.

FIG. 6 shows a sequence of five individual schematic time diagrams 6 a) to 6 e) in which the opening and closing process of the first valve 1 is respectively denoted by the curve denoted by T1 and the opening and closing process of the second valve T2 is analogously denoted by the curve denoted by T2. The increased curve part thus corresponds respectively to the first/second activation time.

In comparison, it can be seen that the first activation time in all five control states on the (arbitrary) time axis in the horizontal direction begins at 0 ms and ends at 13 ms. In contrast, the second activation time with regard to its beginning shifts from initially approximately 2.5 ms in FIG. 6 a) stepwise to approximately 7 ms in FIG. 6 e), whereas the second activation time in all five illustrations ends at approximately 18 ms. Accordingly, there is an overlap time in all control states, namely from 3 ms to 13 ms in FIG. 6 a) to still from 7 ms to 13 ms in FIG. 6 e), wherein this overlap time decreases stepwise, namely corresponding to the increasingly delayed beginning of the second activation time. In this respect, the pneumatic application by the second valve 2 with regard to the return of the projectile 8 is active in all five control states.

In the cases illustrated in FIG. 6, impact speeds of the projectile 8 onto the applicator 6 of (in this order from a) to e)) 10 m/s, 12 m/s, 14 m/s, 16 m/s, and 18 m/s are realized at a pressure of 4 bar. This corresponds to impulses of 30 gm/s to 54 gm/s with a projectile mass of 3 g. The activation time of the valve 1 is constant 13.0 ms. The closing time of the second valve also remains constant at 18 ms. The activation time of the second valve changes (again in the sequence from a) to e)) from 15.4 ms to 15.0 ms, 14.3 ms, 13.0 ms to 10.9 ms, resulting in overlap times of 10.4 ms, 10.0 ms, 9.3 ms, 8.0 ms, and finally 5.9 ms. Accordingly, the activation time of the second valve 2 begins delayed by a time period (increasing from top to bottom) between 2.6 ms and 7.1 ms compared to the first activation time.

In FIG. 6 a) (of course at a start of the projectile movement at the left-hand end of the movement path in FIG. 2 at 0 ms), the collision with the applicator takes place after the overlap time and also after the end of the second activation time, that is to say at approximately 18 ms to 20 ms, wherein this collision time shifts ever further to the left in the following figures and, starting from FIG. 6 c), lies within the second activation time. The projectile speeds measured (optically in an experimental setup) are between 10 m/s in FIGS. 6 a) and 18 m/s in FIG. 6 e) and are therefore in a ratio of 1:1.8.

In this case, it can be imagined in a simplified manner that the projectile is accelerated linearly over time before the second activation time and is then moved further at approximately the speed achieved (disregarding pneumatic flow effects and projectile friction); in fact, the projectile speed will probably increase somewhat less than linearly over time and will slightly decrease in an approximately force-free state during the overlap time on account of friction. After the overlap time, the projectile 8 is braked in all individual illustrations by the still present pneumatic application of pressure by the second valve, wherein, in the cases 6 a) and 6 b), after the end of the second activation time, the projectile again covers a short distance until the collision in an approximately force-free manner in the above sense.

In particular in FIG. 6 a), it is noticeable that the remainder of the second activation time after the overlap time is significantly longer than the (initial) remainder of the first activation time before the overlap time. This may be surprising because the same supply pressure abuts both valves and, according to the real values from the above table of values, a collision nevertheless takes place in FIG. 6 a) at 10 m/s. One reason may be that the second valve 2 according to FIG. 2 is pneumatically connected significantly more inefficiently to the interior of this pipe 7 in the region of the right-hand end of the projectile guide tube 7 than the first valve 1 at the left-hand end. This has to do with the fact that, at the right-hand end, as can be seen in FIG. 2, the projectile 8 is prevented from flying out to the right by a cross-sectional constriction (catching device). This has safety reasons if an apparatus without a mounted applicator were inadvertently put into operation. In this respect, the corresponding pipe end apparently fills more slowly during the opening of the second valve 2 and, therefore, there is a greater delay between the valve switching processes and the actual exertion of force on account of the pneumatic application of pressure by the second valve in a dynamic view.

Otherwise, the figures show that a portion of the second activation time after the collision lies only in the illustrations 6 d) and 6 e). This does not disturb any further, because the projectile is pushed back in the sense of momentum conservation by the collision itself in the sense of the impact between a typically lower-mass projectile and a higher-mass applicator. The remainder of the second activation time after the end of the first activation time in FIGS. 6 d) and e) in this respect only additionally ensures the return movement into the starting position.

Of course, the control times could be adapted to the extent that the overlap time ends approximately respectively at the collision time. In particular, this could be done with a temporal determination of the collision time by the possibility, already illustrated on the basis of FIG. 2, of a measuring coil 31 in the vicinity of the applicator 6. The control time scheme would thus be somewhat more complicated, because the first activation time would have to be ended differently early (from FIG. 6 a) to FIG. 6 e) always earlier). However, the speed of the projectile return movement could be increased and thus in any case an even higher repetition frequency range could also be achieved for the later one of the individual illustrations, that is to say for the higher projectile speeds, namely in that the end of the second activation time is also provided correspondingly differently and in the case of an increasing projectile speed earlier.

Otherwise, electrical control times are also illustrated here, with the result that, for the reasons described, there are actually approximately 2 ms shorter overlap times.

Overall, it is necessary to imagine a controller (according to FIG. 3) which can set control states according to the partial illustrations in FIG. 4 and further control states according to the partial illustrations just explained in FIG. 6. In both cases, the projectile speed during the collision can be influenced by valve switching times with a constant pressure.

FIG. 7 shows approximately a sequence of three operations corresponding to FIG. 4 f). In this case, as a result of the second activation times shown in dashed lines, the projectile 8 is respectively brought back into the starting position again in order then to be accelerated from the chronologically following first activation time again in the direction of the applicator 6. This figure is intended merely to illustrate the possible periodicity of control states, which of course also applies in an analogous manner to the other partial illustrations in FIGS. 4 and 6. In addition, it can be imagined that the successive processes can have deviations from one another, such that the impact process can thus be changed rapidly and freely from one repetition operation to the next.

FIG. 8 shows a recurring sequence of pulses with two different projectile speed ranges (during impact), which are denoted by the reference numerals H and L in FIG. 8. By varying the overlap and separation of the opening times, the efficiency of the controller can be shown here by way of example. Two pulses with a projectile speed approximately in the range L arrive respectively at a pulse with a projectile speed approximately in the range H.

FIG. 9 demonstrates in particular that the collision conditions can be substantially changed from one collision to the next, here with approximately a factor of 3 in the collision speed. The fluctuations within the ranges H and L are in this case unintentional and tolerance-related variations (these are real measured values).

FIG. 9 shows by way of example the control sequence for the valves V1 and V2 in their temporal succession in order to achieve the projectile speed sequences which can be seen in FIG. 8. Different overlaps and separations of pulses relative to one another can be seen.

FIG. 10 sets the succession of the pulses from FIG. 9 more precisely in terms of time, with the result that a repeating sequence can be seen individually here. It can be seen here that pulses between V1 and V2 change their separation and overlap relatively.

The above explanations relate to the apparatus illustrated in FIGS. 1 to 3. They can also be transferred to other apparatuses and dimensions on the basis of simple estimates for the projectile movement. In particular, the reversal points of the projectile movement are easily accessible, for example, via the mentioned measuring coil, possibly an analog measuring coil at the distal end of the movement path or via the detection of the collisions by microphone. On this basis, meaningful estimates can be made on the basis of the above descriptions.

Alternatively, the following procedure can be adopted: a desired operating frequency and a desired supply pressure for the two valves are predefined and, for example, it is also predefined that the two valves open for a constant duration, for example for 25% of the reciprocal of the predefined frequency. The controller can then be set up such that the valves open and close precisely in phase at a starting time. In this state, stable movement will not occur because pressure is applied to the projectile on both sides at the same time or pressure is not applied to it from any side. On this basis, it is then possible to change the offset between opening times in both directions in steps, i.e., to open (and close) the second valve in steps somewhat earlier or somewhat later than the first valve. Starting from a certain time offset, i.e., so to speak, starting from a certain phase shift, a stable vibration state of the projectile will occur, which can be established, for example, with the mentioned microphone determination of the collisions at the two ends of the movement path. In addition, it is then possible to determine the intensity of the collision with the applicator and to consider the described phase shift to some extent as a control parameter for the intensity. In this form, a calibration curve can be determined.

In addition, it is of course possible to maintain the phase offset constant in the case of a certain vibration state determined in this form and to change the first and/or the second valve opening duration in steps.

In the individual case, it could occur that a sufficient pressure was not predefined for the desired frequency, i.e., no vibration state with collisions at the ends of the movement path arises even in the case of “anti-phase” controlling of the two valves. It is then accordingly necessary either to increase the pressure somewhat or to reduce the frequency.

Analogously, it is of course also possible to approach suitable operating states empirically in another form. Finally, it is of course possible to simulate the movement behavior of the projectile at least approximately computationally, and empirical tests can then be undertaken on the basis of the results of such simulations.

1. An apparatus for treatment of the human or animal body with mechanical pressure waves, the apparatus comprising:
a projectile guided in the apparatus along a movement path,
an applicator at one end of the movement path,
pneumatic means for application of pneumatic pressure to the projectile for the purpose of movement along the movement path,
wherein the projectile is adapted for striking onto the applicator for generating the mechanical pressure waves,
which pneumatic means has a double valve means for application of pneumatic pressure to the projectile in the direction towards the applicator during a first activation time and for application of pneumatic pressure to the projectile in the reverse direction during a second activation time and a control means for controlling the double valve means,
wherein the apparatus is adapted to maintain a separation time between the first activation time and the second activation time or vice versa and to control an impact speed of the projectile upon impact onto the applicator by means of the separation time.

2. The apparatus according to claim 1, in which the double valve means has a first valve for application of pneumatic pressure to the projectile in the direction towards the applicator and a second valve for application of pneumatic pressure to the projectile in the reverse direction, which valves can preferably be controlled independently of one another by the control means.

3. The apparatus according to claim 1, in which the double valve means has a “combination valve” which, depending on the control by the control means, assumes a first switching state for application of pneumatic pressure to the projectile in the direction towards the applicator or a second switching state for application of pneumatic pressure to the projectile in the reverse direction, wherein in each of these switching states the pneumatic connection used in the respectively other switching state for application of pneumatic pressure to the projectile is ventilated by the combination valve.

4. The apparatus according to claim 2, in which at least one of the two valves is a two-way valve which applies pneumatic pressure to a pneumatic volume between itself and the projectile in a first switching position during the respective activation time for application of pneumatic pressure to the projectile and which ventilates this pneumatic volume in a second switching position.

5. The apparatus according to claim 1, in which the first activation time is of variable length in comparison between at least two control states with different separation time.

6. The apparatus according to claim 1, adapted, in the case of a part of control states, to end one of the two activation times only after the start of the other of the two activation times and preferably to end the one activation time during the other activation time, so that the first and the second activation time overlap during an overlap time.

7. The apparatus according to claim 6, adapted, in the case of the part of the control states, to control an impact speed of the projectile upon impact onto the applicator by means of a portion of the first activation time outside the overlap time associated therewith.

8. The apparatus according to claim 7, wherein the earlier one of the two activation times is of constant length in comparison between at least two control states with different periods of overlap between the first and the second activation time.

9. The apparatus according to claim 7, wherein the later one of the two activation times is of variable length in comparison between at least two control states with different periods of overlap.

10. The apparatus according to claim 1, wherein the pneumatic means comprises a pneumatic compressor, wherein the apparatus is adapted to allow the compressor in the activated state to run at different control states with different impact speeds of the projectile at the same rotational frequency, preferably in principle in the activated state to run at always the same rotational frequency.

11. The apparatus according to claim 1, wherein the projectile can be moved with an impact pulse of between 2 gm/s and 300 gm/s upon impact onto the applicator.

12. The apparatus according to claim 1, adapted to vary, in an iterative operating state with directly successive forward movements of the projectile for impact onto the applicator and return movements, the impact speed and/or the time duration of the combined forward and return movement from one to the next such combined forward and return movement.

13. The apparatus according to claim 1, having a measuring means for detecting a passage of the projectile at a point of the movement path, which measuring means is coupled to the control means.
